(19) United States
(12) Patent Application Publication
(10) Pub. No.: US 2022/0198744 A1
(43) Pub. Date: Jun. 23, 2022

(54) DISPLAY SYSTEM, DISPLAY DEVICE, AND PROGRAM

(71) Applicant: TOYOTA JIDOSHA KABUSHIKI KAISHA, Toyota-shi (JP)

(72) Inventors: Kazuki KOMORIYA, Toyota-shi (JP); Kazumi SERIZAWA, Toyota-shi (JP); Sayaka ISHIKAWA, Miyoshi-shi (JP); Shunsuke TANIMORI, Nagoya-shi (JP); Masaya MIURA, Toyota-shi (JP); Kouji TAMURA, Tokyo (JP); Seiei HIBINO, Nagakute-shi (JP); Rina MUKAI, Toyota-shi (JP); Tomoya INAGAKI, Miyoshi-shi (JP); Chinli DI, Nagoya-shi (JP)

(73) Assignee: TOYOTA JIDOSHA KABUSHIKI KAISHA, Toyota-shi (JP)

(21) Appl. No.: 17/551,414

(22) Filed: Dec. 15, 2021

(30) Foreign Application Priority Data
Dec. 21, 2020 (JP) 2020-211166

(51) Int. Cl. G06T 15/20; G06T 19/20; G06T 19/00; G06T 7/70; G06V 20/20; G06V 40/10

(52) U.S. Cl. CPC G06T 15/205; G06T 19/20; G06T 19/006; G06T 2207/30196; G06V 20/20; G06V 40/10; G06T 2215/16; G06T 7/70

(57) ABSTRACT

A display device includes an image recognition unit, a display control unit, a display unit, and a position information acquisition unit. The image recognition unit recognizes a person image from an image captured at a remote location. The display control unit is configured to superimpose a decoration image on the person image and generate an augmented reality image in which the person image that has been decorated is superimposed on scenery of a real world. The position information acquisition unit acquires a position of the position information acquisition unit. The server includes a decoration image storage unit and a decoration image extraction unit. In the decoration image storage unit, a plurality of kinds of the decoration images is stored. The decoration image extraction unit extracts, from the decoration image storage unit, the decoration image based on the position, as the decoration image to be superimposed on the person image.

### CROSS-REFERENCE TO RELATED APPLICATION

This application claims priority to Japanese Patent Application No. 2020-211166 filed on Dec. 21, 2020, incorporated herein by reference in its entirety.

### BACKGROUND

### 1. Technical Field

The present specification discloses a display system, a display device, and a program for displaying an augmented reality (AR) image.

### 2. Description of Related Art

A display device using augmented reality technology has been known. For example, in Japanese Unexamined Patent Application Publication (Translation of PCT Application) No. 2016-522485 (JP 2016-522485 A), an augmented reality image in which a real object such as an action figure that is a toy is replaced with a virtual object such as a virtual action figure with animation is displayed.

### SUMMARY

The augmented reality technology as described above enables remote communication. In a facility such as a theme park, for example, with the augmented reality technology, it is possible to produce an effect as if a person at a remote location was traveling around the facility, by superimposing an image of the person at the remote location on a captured image of the facility.

The present specification discloses a display system, a display device, and a program capable of displaying an augmented reality image that matches the concept of the surroundings.

The present specification discloses a display system. The display system includes a display device and a server. The display device includes an image recognition unit, a display control unit, a display unit, and a position information acquisition unit. The image recognition unit recognizes a person image from an image captured at a remote location. The display control unit is configured to superimpose a decoration image on the person image and generate an augmented reality image in which the person image that has been decorated is superimposed on scenery of a real world. The display unit is configured to display the augmented reality image. The position information acquisition unit acquires a position of the position information acquisition unit. The server includes a storage unit and an extraction unit. In the storage unit, a plurality of kinds of the decoration images is stored. The extraction unit extracts, from the storage unit, the decoration image based on the position acquired by the position information acquisition unit, as the decoration image to be superimposed on the person image.

According to the above configuration, a virtual image in which the person image of the remote location is decorated based on the position of the display device can be superimposed on the display unit. This makes it possible to produce an effect that the person image of the remote location is decorated in accordance with the concept of the facility in which the display device is located.

In the above configuration, the display device may be disposed in a facility configured based on a specific theme. In this case, in the storage unit, a character image defined as a character in the facility is stored as the decoration image.

According to the above configuration, it is possible to produce an effect that the person at the remote location plays a character in the facility.

In the above configuration, an identifier that is imageable may be displayed on a device in the facility. In this case, the display device includes an imager configured to image an inside of the facility. When the image recognition unit recognizes the identifier in an in-facility captured image captured by the imager, the display control unit sets an image area including the identifier as a superimposed area of the person image that has been decorated.

According to the above configuration, since the superimposed area of the person image of the remote location in the in-facility captured image is defined, unnatural superimposition such as superimposition of the person image in the air is suppressed.

In the above configuration, the display system may include a first caller configured to make a call in the facility, and a second caller configured to make a call with the first caller at the remote location.

According to the above configuration, it is possible to have a conversation with the person superimposed in the augmented reality image in the facility.

The present specification also discloses a display device. The display device includes an image recognition unit, a display control unit, a display unit, a position information acquisition unit, a storage unit, and an extraction unit. The image recognition unit recognizes a person image from an image captured at a remote location. The display control unit is configured to superimpose a decoration image on the person image and generate an augmented reality image in which the person image that has been decorated is superimposed on scenery of a real world. The display unit is configured to display the augmented reality image. The position information acquisition unit acquires a position of the position information acquisition unit. In the storage unit, a plurality of kinds of the decoration images is stored. The extraction unit extracts, from the storage unit, the decoration image based on the position acquired by the position information acquisition unit, as the decoration image to be superimposed on the person image.

The present specification also discloses a program. The program causes a computer to function as an image recognition unit, a display control unit, a display unit, a position information acquisition unit, a storage unit, and an extraction unit. The image recognition unit recognizes a person image from an image captured at a remote location. The display control unit is configured to superimpose a decoration image on the person image and generate an augmented reality image in which the person image that has been decorated is superimposed on scenery of a real world. The display unit is configured to display the augmented reality image. The position information acquisition unit acquires a position of the position information acquisition unit. In the storage unit, a plurality of kinds of the decoration images is stored. The extraction unit extracts, from the storage unit, the decoration image based on the position acquired by the position information acquisition unit, as the decoration image to be superimposed on the person image.

With the display system, the display device, and the program disclosed in the present specification, it is possible to display an augmented reality image that matches the concept of the surroundings.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram illustrating a complex entertainment facility in which a display system according to the present embodiment is used and a house at a remote location therefrom;

FIG. 2 is a diagram illustrating the inside of a vehicle that can travel in the complex entertainment facility;

FIG. 3 is a diagram illustrating a hardware configuration of devices included in the display system according to the present embodiment;

FIG. 4 is a diagram illustrating functional blocks of the display system according to the present embodiment;

FIG. 5 is a diagram illustrating a display control flow by the display system according to the present embodiment;

FIG. 6 is a diagram showing an example in which a person image of the remote location is superimposed on an image of the real world;

FIG. 7 is a diagram showing an example in which the person image of the remote location that has been decorated is superimposed on the image of the real world;

FIG. 8 is a diagram illustrating a head-mounted display (HMD) as another example of the display device; and

FIG. 9 is a diagram showing another example of the functional blocks of the display device, in which a server function is included.

### DETAILED DESCRIPTION OF EMBODIMENTS

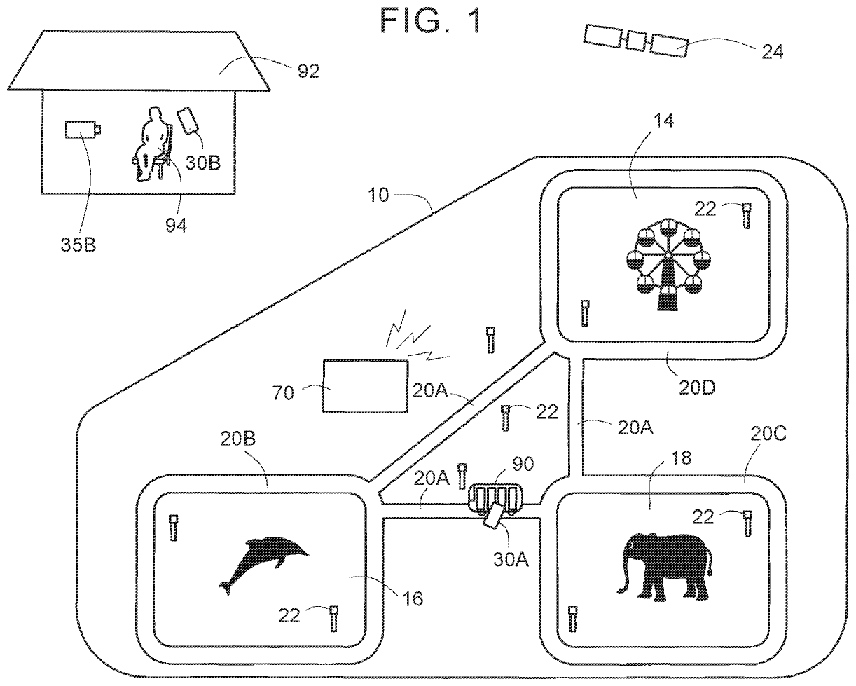

FIG. 1 illustrates a complex entertainment facility 10 in which a display system according to the present embodiment is used and a house 92 at a remote location from the facility.

Configuration of Complex Entertainment Facility

The complex entertainment facility 10 includes a plurality of theme parks 14 to 18. The theme park refers to a facility having a concept based on a specific theme (subject) and including facilities, events, scenery, and the like that are comprehensively organized and produced based on that concept. For example, the theme parks 14 to 18 are connected by connecting passages 20A, and users can come and go between the theme parks 14 to 18 through the connecting passages 20A.

The complex entertainment facility 10 includes theme parks having different themes. For example, the complex entertainment facility 10 includes an amusement park 14, an aquarium 16, and a zoo 18 as the theme parks.

Characters are set for each of the theme parks 14 to 18 based on their respective themes. The characters are set so as to match the theme and the concept of each of the theme parks 14 to 18. For example, for the amusement park 14, characters such as a clown and a go-kart are set. For example, for the aquarium 16, characters such as a dolphin, goldfish, and a shark are set. Further, for example, for the zoo 18, characters such as an elephant, a lion, and a panda are set.

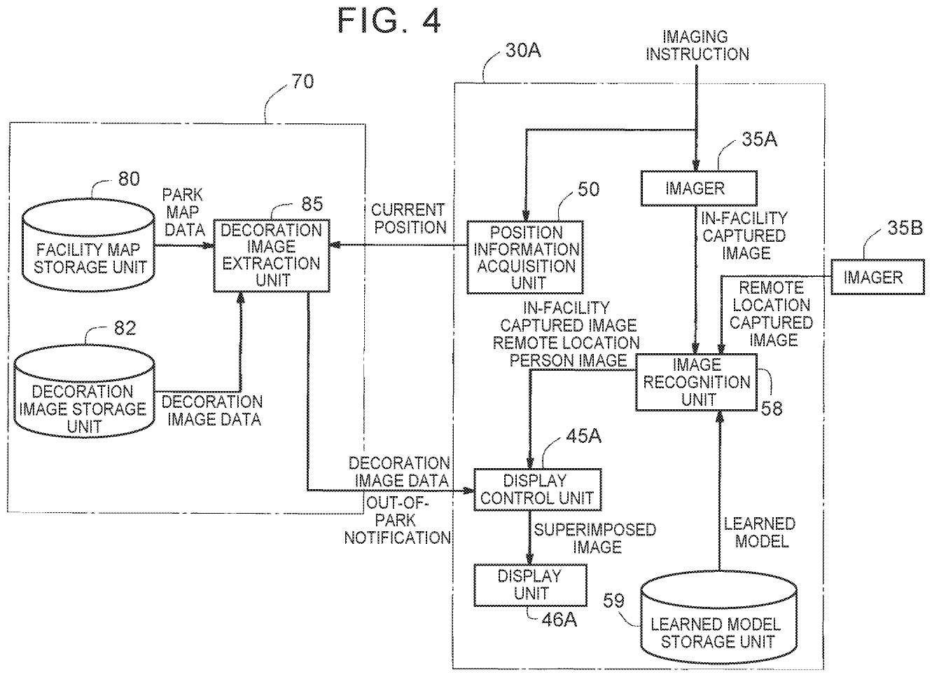

Images of these characters (hereinafter, appropriately referred to as character images) are used as decoration images for decorating a person image captured at a remote location, as will be described later. The character image data of the theme parks 14 to 18 is stored in a decoration image storage unit 82 of a server 70 (see FIG. 4) while being associated with identification codes of the theme parks 14 to 18. The server 70 is installed, for example, in an administrator's building (not shown) provided in the complex entertainment facility 10. Details of the character image data stored in the decoration image storage unit 82 will be described later.

In each of the theme parks 14 to 18, in-park passages 20B to 20D are provided. The in-park passages 20B to 20D are connected to the connecting passages 20A, and a vehicle 90 can travel through these passages.

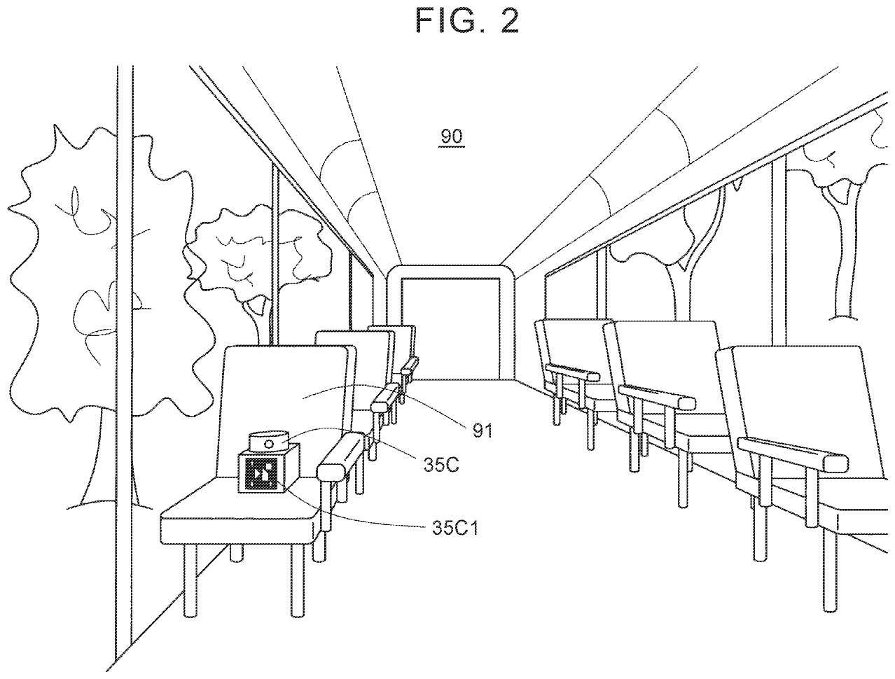

FIG. 2 illustrates the inside of the vehicle 90. The vehicle 90 may be, for example, a small-sized, so-called low-speed mobile body (mobility) with four seats, six seats or the like that can be used by a family. An imager 35C is provided inside the vehicle 90. The imager 35C can capture an image of the scenery in the complex entertainment facility 10, and can display the captured image on a display device 30B (see FIG. 1) placed at a remote location as described later. Details of the imager 35C will be described later.

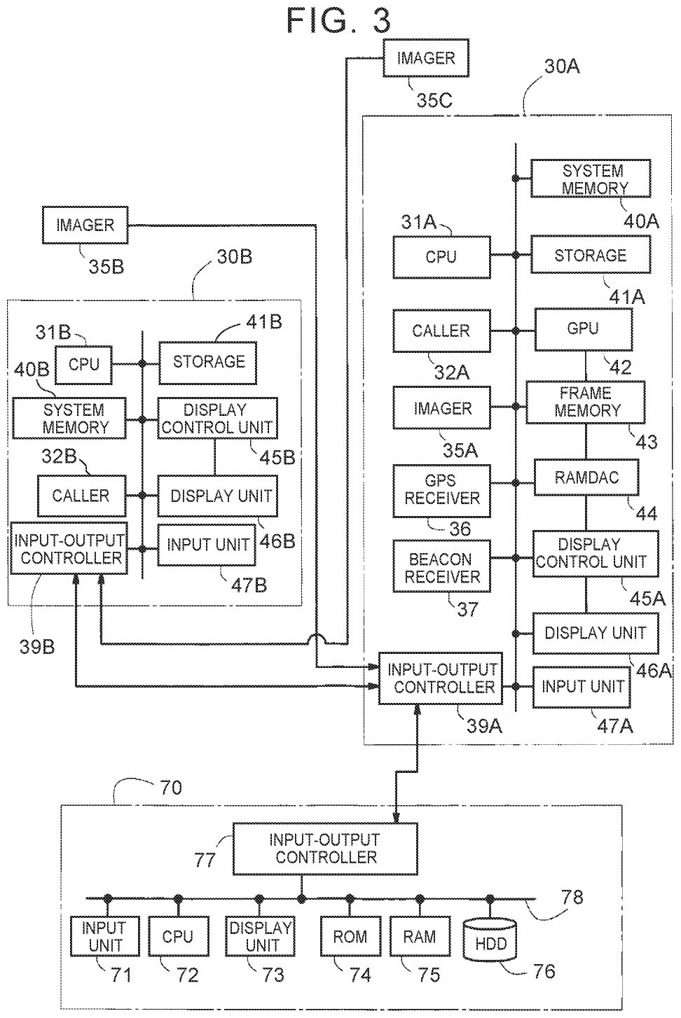

A beacon transmitter 22 is provided along the connecting passages 20A and the in-park passages 20B to 20D of the complex entertainment facility 10. A plurality of transmitters 22 are provided, for example, at equal intervals. As will be described later, when a beacon receiver 37 (see FIG. 3) of a display device 30A receives a signal from the transmitter 22, the current position of the display device 30A can be acquired.

The display device 30B and an imager 35B are disposed in the house 92 at the remote location distant from the complex entertainment facility 10. The display device 30B and the imager 35B are operated by, for example, a person 94 in the house 92. The imager 35B and the display device 30B only need to be placed in such an environment that the imager 35B and the display device 30B can be operated by the person 94 at the remote location and can communicate with the display device 30A and the imager 35C. For example, the imager 35B and the display device 30B may be placed outdoors, instead of being placed in the house 92.

As described in detail below, a display system according to the present embodiment causes the display device 30A carried by a visitor of the complex entertainment facility 10 to display an image of the person 94 at the remote location. Examples of the visitor to the complex entertainment facility 10 include a family, and examples of the person 94 at the remote location include a guardian included in the family and on assignment at the remote location, an elderly relative having mobility difficulties, and the like.

Further, in the display system according to the present embodiment, when displaying the image of the person 94 at the remote location on the display device 30A, image processing of superimposing a decoration image on the person image is executed. For the decoration image, a character image set for the theme park, out of the theme parks 14 to 18, where the display device 30A is located is extracted.

Configuration of Devices of Display System

FIG. 3 illustrates a hardware configuration of the devices included in the display system according to the present embodiment. The display system according to the present embodiment includes the display devices 30A and 30B, the imagers 35B and 35C, and the server 70.

Here, focusing on the function that the image of the person 94 at the remote location is decorated with the decoration image and the decorated image is superimposed on the scenery of the complex entertainment facility 10 that is the scenery of the real world, the display system only needs to include at least the display device 30A, the imager 35B, and the server 70. Configuration of Display Device 30B

The display device 30B is operated and used by the person 94 at the remote location (see FIG. 1). The display device 30B may be, for example, a smartphone. The display device 30B includes a central processing unit (CPU) 31B serving as an arithmetic device, a system memory 40B and a storage device 41B serving as storage devices.

The display device 30B also includes a display unit 46B and a display control unit 45B that controls a display image on the display unit 46B. Further, the display device 30B includes an input unit 47B for inputting information. For example, the display device 30B is provided with a touch panel display in which the input unit 47B and the display unit 46B are integrated. The display device 30B is also provided with a caller 32B (second caller) that can make a call with the display device 30A from the remote location. Further, the display device 30B includes an input-output controller 39B that manages input and output of information.

The display device 30B can wirelessly communicate with the display device 30A via a communication line, a base station of a telecommunications carrier, or the like (not shown). The data to be transmitted includes, for example, voice data sent from the person 94 at the remote location to the caller 32B.

The imager 35B is disposed near the display device 30B and can be operated by the person 94 at the remote location. The imager 35B includes an imaging device such as a complementary metal oxide semiconductor (CMOS) imaging device or a charge coupled device (CCD) imaging device. The imager 35B can capture a still image and a moving image.

The imager 35B can capture an image of the scenery of the real world that includes the person 94 at the remote location. For example, the imager 35B is set apart from the person 94 by a predetermined distance in order to capture the whole body image of the person 94 at the remote location in the field of view.

Further, the imager 35B may be a so-called RGB-D camera having a function of measuring the distance of the subject from the imager 35B in addition to a function of imaging the real world. As the function of measuring the distance, for example, the imager 35B is provided with a distance measuring mechanism using infrared rays, in addition to the above-mentioned imaging device.

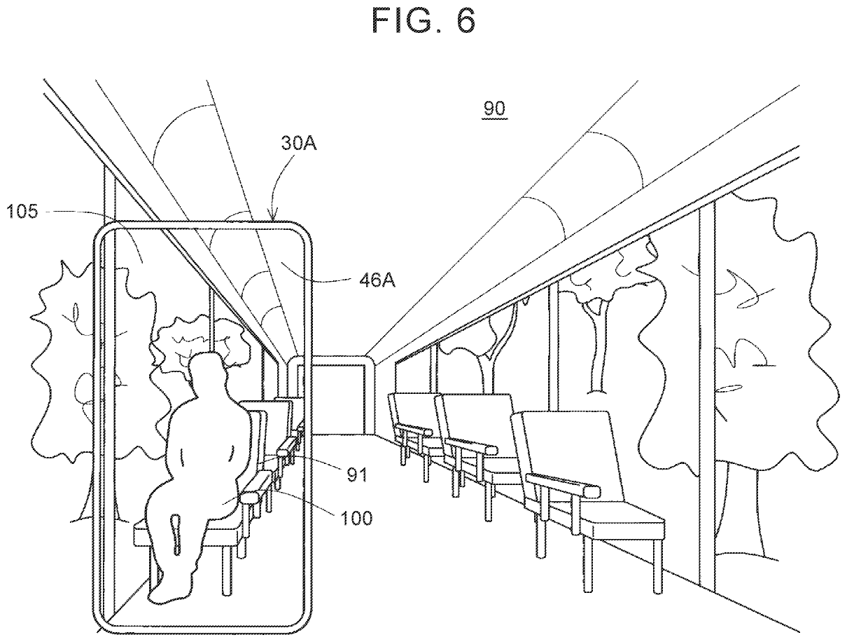

The imager 35B is connected to a communication line, and data of the image including the person 94 at the remote location (hereinafter, appropriately referred to as remote location captured image) is transmitted to the display device 30A. In response to this, a display unit 46A of the display device 30A can display a person image 100 (see FIG. 6) of the remote location.

Configuration of Imager 35C

The imager 35C is disposed in the complex entertainment facility 10. The imager 35C includes, similar to the imager 35B, an imaging device such as a CMOS imaging device or a CCD imaging device. The imager 35C can capture a still image and a moving image. Further, the imager 35C is provided with a distance measuring mechanism using infrared rays.

FIG. 2 shows an example in which the imager 35C is disposed in the vehicle 90 traveling in the complex entertainment facility 10. The imager 35C is disposed on a seat 91 in the vehicle, more specifically on the seat surface thereof The imager 35C may be a portable device carried by a visitor of the complex entertainment facility 10. In this case, the imager 35C may be a so-called alter-ego robot. Further, the imager 35C may be a stationary device fixed to the seat 91.

The imager 35C can wirelessly communicate with the display device 30B at the remote location via a communication line and a base station of a telecommunications carrier or the like (not shown), and the captured still image data or moving image data is transmitted to the display device 30B.

With reference to FIG. 2, the imager 35C is provided with a rotation axis perpendicular to the placement surface (seat surface), and can swivel around the rotation axis. For example, when an operation signal is received from the input unit 47B (see FIG. 3) of the display device 30B at the remote location, the imager 35C swivels to change its field of view in response to the signal. As a result, the person 94 at the remote location can see the desired scenery in the complex entertainment facility 10 through the display device 30B.

Further, an augmented reality (AR) marker 35C1 that is an imageable identifier is indicated on the imager 35C. The AR marker 35C1 is printed on the surface of the imager 35C. The AR marker 35C1 is an identifier that is used when an augmented reality image is displayed, and indicates, for example, a display area of a virtual image to be superimposed. For example, when the inside of the vehicle 90 is imaged, the image area including the AR marker 35C1 is set as the superimposed area of the virtual image.

In this way, by displaying the AR marker 35C1 that is the identifier in the complex entertainment facility 10 in an imageable state, it is possible to set the superimposed area of the person image 100 of the remote location (see FIG. 6). For example, it is possible to produce an effect as if the person 94 at the remote location was sitting on the seat 91.

Configuration of Server

With reference to FIG. 3, the server 70 is composed of, for example, a computer, and is installed in, for example, a management building of the complex entertainment facility 10 (see FIG. 1). Further, the server 70 is wirelessly connected to the display device 30A by a communication means such as a wireless LAN.

The server 70 includes an input unit 71 such as a keyboard and a mouse, a central processing unit (CPU) 72 serving as an arithmetic device, and a display unit 73 such as a display. The server 70 also includes a read-only memory (ROM) 74, a random access memory (RAM) 75, and a hard disk drive (HDD) 76 as storage devices. Further, the server 70 includes an input-output controller 77 that manages input and output of information. These components are connected to an internal bus 78.

FIG. 4 illustrates functional blocks of the server 70. The functional block diagram is configured such that the CPU 72 executes a program stored in, for example, the ROM 74 or the HDD 76 or stored in a computer-readable non-transitory storage medium such as a digital versatile disc (DVD).

The server 70 includes a facility map storage unit 80, a decoration image storage unit 82, and a decoration image extraction unit 85.

The facility map storage unit 80 stores map information of the complex entertainment facility 10. For example, the facility map storage unit 80 stores position information of the passages (connecting passages 20A and in-park passages 20B to 20D) and facilities in the complex entertainment facility 10. Specifically, the facility map storage unit 80 stores plan view data of the complex entertainment facility 10 that is associated with the position information. The position information includes longitude and latitude information using the GPS function and position information using the beacon function.

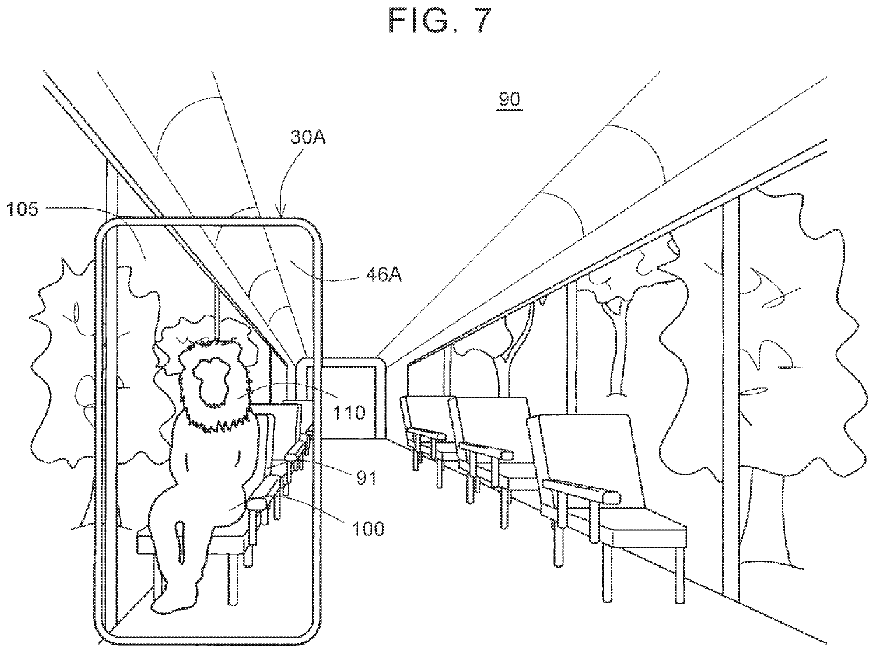

The decoration image storage unit 82 stores the decoration image data including virtual objects, out of the augmented reality images that are displayed on the display device 30A. FIG. 7 shows an image of a lion's head as a decoration image 110. The decoration image 110 is superimposed on the person image 100 transmitted from the remote location.

The decoration image data stored in the decoration image storage unit 82 may be three-dimensional (3D) model data of a decoration object that is a virtual object. The 3D model data includes, for example, 3D image data of the decoration object, and the 3D image data includes shape data, texture data, and motion data.

A plurality of kinds of decoration image data is stored in the decoration image storage unit 82 for each of the theme parks 14 to 18. For example, 10 to 100 kinds of decoration image data for one theme park is stored in the decoration image storage unit 82. The decoration image data is individually provided with an identification code of a corresponding theme park, out of the theme parks 14 to 18. Further, a unique identification code is provided to each piece of the decoration image data.

The decoration image data is, for example, a character image defined as a character for a theme park, out of the theme parks 14 to 18. For example, the decoration image 110 provided with the identification code corresponding to the amusement park 14 includes an image of a large ball for ball riding. Further, the decoration image 110 provided with the identification code corresponding to the aquarium 16 includes an image of an arch of a school of fish.

In FIG. 7, contour drawings are shown as the person image 100 and the decoration image 110 in order to clarify the illustration, but the present disclosure is not limited to this form. The 3D images of the person image 100 and the decoration image 110 may be displayed.

The decoration image extraction unit 85 determines which of the theme parks 14 to 18 of the complex entertainment facility 10 the display device 30A is located in, based on the current position information acquired by a position information acquisition unit 50 (see FIG. 4) of the display device 30A. Further, when the display device 30A is located in any of the theme parks 14 to 18, the decoration image extraction unit 85 extracts, from the decoration image storage unit 82, the decoration image data that is set corresponding to the theme park, out of the theme parks 14 to 18, and transmits the decoration image data to the display device 30A.

Configuration of Display Device 30A

With reference to FIG. 1, the display device 30A is disposed in the complex entertainment facility 10 and is used by a visitor (user) of the facility. The display device 30A can display a virtual reality image in which an image of a virtual object is superimposed on scenery of the real world.

The display device 30A may be a portable device. For example, the display device 30A is a smartphone provided with an imaging device and a display unit, or a glasses-type head-mounted display (HMD).

The display device 30A can be divided into a video see-through display (VST display) and an optical see-through display (OST display) from a viewpoint of the mode of displaying scenery of the real world. In the VST display, an imager such as a camera captures an image of scenery of the real world, and the captured image is displayed on the display unit. On the other hand, in the OST display, scenery of the real world is visually recognized through a transmissive display unit such as a half mirror, and a virtual object is projected onto the display unit.

The display device 30A provided with an imager 35A (see FIG. 3), such as the smartphone mentioned above, is classified as the VST display. The head-mounted display (HMD) mentioned above is classified as the OST display because the scenery of the real world is visually recognized with the lenses of eyeglasses used as the display unit.

In the embodiment below, as shown in FIG. 6, a portable, VST display-type smartphone is illustrated as an example of the display device 30A. This smartphone may be property of the user of the complex entertainment facility 10, or may be a leased item such as a tablet terminal to be lent to the user of the complex entertainment facility 10.

FIG. 3 illustrates a hardware configuration of the display device 30A. The display device 30A includes a central processing unit (CPU) 31A, a caller 32A (first caller), the imager 35A, a Global Positioning System (GPS) receiver 36, the beacon receiver 37, the input-output controller 39A, a system memory 40A, a storage device 41A, a graphics processing unit (GPU) 42, a frame memory 43, a RAM digital-to-analog converter (RAMDAC) 44, a display control unit 45A, a display unit 46A, and an input unit 47A.

The system memory 40A is a storage device used by an operating system (OS) executed by the CPU 31A. The storage device 41A is an external storage device, and stores, for example, a program for displaying a virtual reality image (AR image), which will be described later.

The imager 35A is, for example, a camera device mounted on a smartphone, and can capture an image of the scenery of the real world as a still image or a moving image. The imager 35A includes an imaging device such as a CMOS imaging device or a CCD imaging device. Further, the imager 35A may be a so-called RGB-D camera having a function of measuring the distance from the imager 35A in addition to a function of imaging the real world. As the function of measuring the distance, for example, the imager 35A is provided with a distance measuring mechanism using infrared rays, in addition to the above-mentioned imaging device.

The GPU 42 is an arithmetic device for image processing, and is mainly operated when image recognition described later is performed. The frame memory 43 is a storage device that stores an image captured by the imager 35A and subjected to computation by the GPU 42. The RAMDAC 44 converts the image data stored in the frame memory 43 into analog signals for the display unit 46A that is an analog display.

The GPS receiver 36 receives GPS signals that are positioning signals from a GPS satellite 24 (see FIG. 1). The GPS signal includes position coordinate information of latitude, longitude, and altitude. The beacon receiver 37 receives position signals output from the beacon transmitters 22 installed in the complex entertainment facility 10 including the connecting passages 20A and the in-park passages 20B to 20D.

Here, both the GPS receiver 36 and the beacon receiver 37 have overlapping position estimation functions. Therefore, the display device 30A may be provided with only one of the GPS receiver 36 and the beacon receiver 37.

The input unit 47A can input an activation instruction and an imaging instruction to the imager 35A. For example, the input unit 47A may be a touch panel integrated with the display unit 46A.

The display control unit 45A can generate an augmented reality image (AR image) in which an image of a virtual object is superimposed on scenery of the real world and display the AR image on the display unit 46A. For example, the display control unit 45A superimposes the virtual image on the image area of the AR marker 35C1 (see FIG. 2), out of the in-facility image obtained by capturing the image in the complex entertainment facility 10. This virtual image includes the person image 100 transmitted from the remote location and further decorated with the decoration image 110 (see FIG. 7). This decoration process is executed by the display control unit 45A. The augmented reality image in which the decorated person image 100 is superimposed on the in-facility image is displayed on the display unit 46A by the display control unit 45A. The display unit 46A may be, for example, a liquid crystal display or an organic electroluminescence (EL) display.

FIG. 4 illustrates a functional block diagram of the display device 30A. This functional block diagram is configured such that the CPU 31A or the GPU 42 executes a program stored in, for example, the system memory 40A or the storage device 41A. Alternatively, the functional blocks illustrated in FIG. 4 are configured such that the CPU 31A or the GPU 42 executes a program stored in a computer-readable non-transitory storage medium such as a DVD or a hard disk of a computer.

FIG. 4 shows the configuration of the display device 30A with a part of the hardware configuration illustrated in FIG. 3 and the functional blocks in a combined state. FIG. 4 illustrates the imager 35A, the display control unit 45A, and the display unit 46A as the hardware configuration.

Further, as the functional blocks, the display device 30A includes the position information acquisition unit 50 and an image recognition unit 58. The display device 30A includes a learned model storage unit 59 as a storage unit. These functional blocks are composed of the CPU 31A, the system memory 40A, the storage device 41A, the GPU 42, the frame memory 43, and the like.

The position information acquisition unit 50 acquires information on the current position of the position information acquisition unit 50 from at least one of the GPS receiver 36 and the beacon receiver 37 in FIG. 3. This position information is position information of a so-called world coordinate system, and in the case of GPS signals, latitude, longitude and altitude information is included in the position information. When the received position information is acquired from the beacon signal, the position information includes, for example, the x-coordinate and the y-coordinate of the plane coordinate system with a point in the complex entertainment facility 10 set as the origin.

The image recognition unit 58 receives the image data captured by the imagers 35A and 35B and performs image recognition. The image recognition includes recognition of objects in the captured image and estimation of the distance of each object from the display device 30A and the imager 35B. In such image recognition, the captured image data includes, for example, a color image data obtained by imaging the scenery of the real world as well as distance data of each object in the color image data from the imagers 35A and 35B, as described above.

The image recognition unit 58 recognizes the captured image using the learned model for image recognition stored in the learned model storage unit 59. The learned model storage unit 59 stores, for example, a neural network for image recognition that has been trained by an external server or the like. For example, outdoor image data containing the complex entertainment facility 10, in which each object in the image has been segmented and annotated, is prepared as training data. In addition, training data for recognizing the person image from the captured image is also prepared. Using the training data, a multi-level neural network is formed that has machine-learned by supervised learning, and is stored in the learned model storage unit 59. This neural network may be, for example, a convolutional neural network (CNN).

As will be described later, by using the learned model, the image recognition unit 58 can recognize and extract the person image from the captured image captured by the imager 35B at the remote location. Further, by using the learned model, the image recognition unit 58 can recognize the AR marker 35C1 that is the identifier displayed in the complex entertainment facility 10.

Augmented Reality Image Display Flow

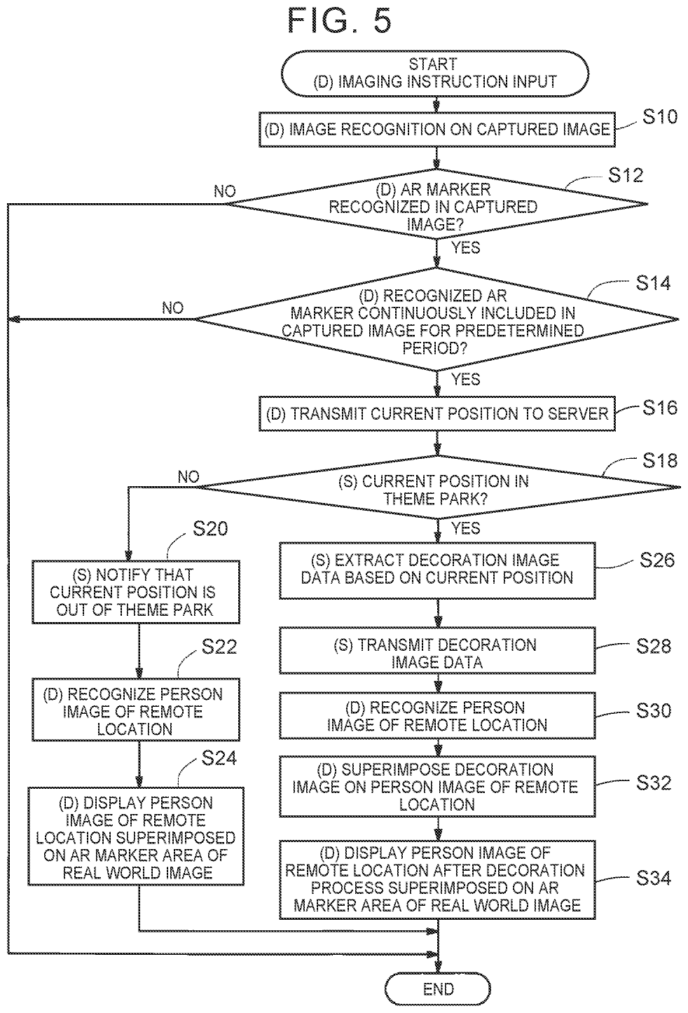

FIG. 5 illustrates an augmented reality image display flow by the display system according to the present embodiment. In the following, the augmented reality image includes an image in which an image of a person at a remote location distant from the complex entertainment facility 10 is superimposed on the scenery in the complex entertainment facility 10. In addition, the augmented reality image includes an image in which a decorated person image in which a virtual decoration image is superimposed on the person image is superimposed on the scenery in the complex entertainment facility 10.

The display flow illustrated in FIG. 5 is executed by the CPUs 31A and 72 executing a program stored in the system memory 40A and the storage device 41A of the display device 30A (see FIG. 3), and the ROM 74 and the hard disk drive 76 of the server 70, for example. Alternatively, the display flow in FIG. 5 is executed by the CPUs 31A and 72 executing a program stored in a computer-readable non-transitory storage medium such as a DVD or a hard disk of a computer.

In FIG. 5, the steps executed by the display device 30A are indicated by (D), and the steps executed by the server 70 are indicated by (S). Further, as a preparation for executing the flow, the person 94 (see FIG. 1) is imaged by the imager 35B at the remote location. Further, the imager 35C is disposed in the complex entertainment facility 10, for example, on the seat 91 of the vehicle 90 (FIG. 2), and the image, that is, an in-facility captured image is transmitted to the display device 30B at the remote location. In addition, the caller 32A (first caller) of the display device 30A in the complex entertainment facility 10 and the caller 32B (second caller) of the display device 30B at the remote location can make a call with each other.

With reference to FIGS. 3 and 4 in addition to FIG. 5, when the imaging instruction is input from the input unit 47A of the display device 30A, the flow is activated. The imager 35A captures an image of the real world, that is, an image in the complex entertainment facility 10 based on the imaging instruction. The obtained in-facility captured image data is transmitted to the image recognition unit 58.

The image recognition unit 58 performs image recognition on the received in-facility captured image (S10). The image recognition includes recognition of the AR marker 35C1 that is the identifier included in the in-facility captured image. The recognition also includes segmentation and annotation of objects in the in-facility captured image. Further, in the image recognition, the distance of each object from the display device 30A is obtained.

The image recognition unit 58 determines whether the AR marker 35C1 is recognized in the captured image (S12). When the AR marker 35C1 is not recognized, the flow ends. On the other hand, when the AR marker 35C1 is recognized in the captured image, the image recognition unit 58 tracks the AR marker 35C1 for a predetermined period (performs so-called marker tracking), and determines whether the AR marker 35C1 is continuously included in the captured image for the predetermined period (S14). The predetermined period may be, for example, five seconds or more and 10 seconds or less.

When the AR marker 35C1 disappears from the captured image during the predetermined period, it is considered to be a so-called unintended reflection, and therefore, generation of the augmented reality image activated by the AR marker 35C1 is not carried out. That is, the display of the augmented reality image on the display unit 46A is suspended. On the other hand, when the AR marker 35C1 is continuously included in the captured image for the predetermined period, the image recognition unit 58 sets the image area of the AR marker 35C1 as the superimposed area of the person image 100 (see FIG. 7) and the decoration image 110.

Further, the position information acquisition unit 50 acquires the current position of the display device 30A. This current position information is transmitted to the server 70 (S16). When the server 70 receives the current position information of the display device 30A, the decoration image extraction unit 85 checks which position of the complex entertainment facility 10 the current position of the display device 30A corresponds to, from the park map data stored in the facility map storage unit 80. Further, the decoration image extraction unit 85 determines whether the current position of the display device 30A is included in any of the theme parks 14 to 18 (S18).

When the current position of the display device 30A is not included in any of the theme parks 14 to 18, the decoration image extraction unit 85 notifies the display device 30A that the current position is not included in the theme parks 14 to 18 (S20). For example, when the vehicle 90 (see FIG. 1) is traveling in the connecting passage 20A, an out-of-park notification is transmitted to the display device 30A.

Upon receiving the out-of-park notification, the image recognition unit 58 of the display device 30A acquires the data of the captured image of the remote location from the imager 35B at the remote location. Further, the image recognition unit 58 recognizes the person image from the acquired remote location captured image (S22).

The image recognition unit 58 extracts the person image 100 (see FIG. 6) from the remote location captured image, and transmits the image data to the display control unit 45A. The image recognition unit 58 also transmits to the display control unit 45A the data of the in-facility captured image that has already been subjected to the image recognition, more specifically, from which the AR marker 35C1 has been recognized.

As illustrated in FIG. 6, the display control unit 45A causes the display unit 46A to display the augmented reality image in which the person image 100 is superimposed on the in-facility captured image 105 (S24). For example, the display control unit 45A obtains the center of gravity of the image area of the AR marker 35C1 and also obtains the center of gravity of the image area of the person. Further, the person image 100 is superimposed on the in-facility captured image 105 such that the center of gravity of the image area of the AR marker 35C1 coincides with the center of gravity of the image area of the person. By such image processing, it is possible to produce an effect as if the person 94 at the remote location was in the complex entertainment facility 10.

Returning to step S18, when the decoration image extraction unit 85 of the server 70 determines that the current position of the display device 30A is included in any of the theme parks 14 to 18, the decoration image extraction unit 85 extracts the decoration image 110 (see FIG. 7). That is, the decoration image extraction unit 85 extracts the data of the decoration image 110 associated with the theme park, out of the theme parks 14 to 18, in which the display device 30A is staying, from the decoration image storage unit 82 (S26).

For example, the decoration image extraction unit 85 extracts the data of the decoration image 110 with the identification code of the theme park, out of the theme parks 14 to 18, in which the display device 30A is staying. When a plurality of kinds of decoration images is stored for each of the theme parks 14 to 18, an appropriate image is extracted from the decoration images with the identification code of the same theme park.

Further, the decoration image extraction unit 85 transmits the extracted decoration image to the display device 30A (S28). Further, the image recognition unit 58 of the display device 30A recognizes the person image from the captured image of the remote location that is acquired from the imager 35B at the remote location and extracts the recognized image (S30). The display control unit 45A of the display device 30A executes a decoration process of superimposing the decoration image 110 acquired from the decoration image extraction unit 85 on the person image 100 of the remote location that is acquired from the image recognition unit 58 (S32).

For example, in this decoration process, the display control unit 45A associates body parts of the person image 100 with body parts of the decoration image. For example, when the decoration image 110 is an image of the head of an animal, the image recognition unit 58 estimates the head of the person image 100 by image recognition of the person image 100. Further, the display control unit 45A defines the head region of the person image 100 as the superimposed region of the decoration image 110.

As illustrated in FIG. 7, the display control unit 45A causes the display unit 46A to display the augmented reality image in which the decorated person image 100 (after decoration process) is superimposed on the in-facility captured image 105 (S34). For example, the display control unit 45A obtains the center of gravity of the image area of the AR marker 35C1 and also obtains the center of gravity of the decorated image area of the person. Further, the person image 100 is superimposed on the in-facility captured image 105 such that the center of gravity of the image area of the AR marker 35C1 coincides with the center of gravity of the image area of the person. By such image processing, it is possible to produce an effect that the person 94 at the remote location is playing a character of the theme park, out of the theme parks 14 to 18, that the visitors of the complex entertainment facility 10 are visiting.

Other Example of Display Device

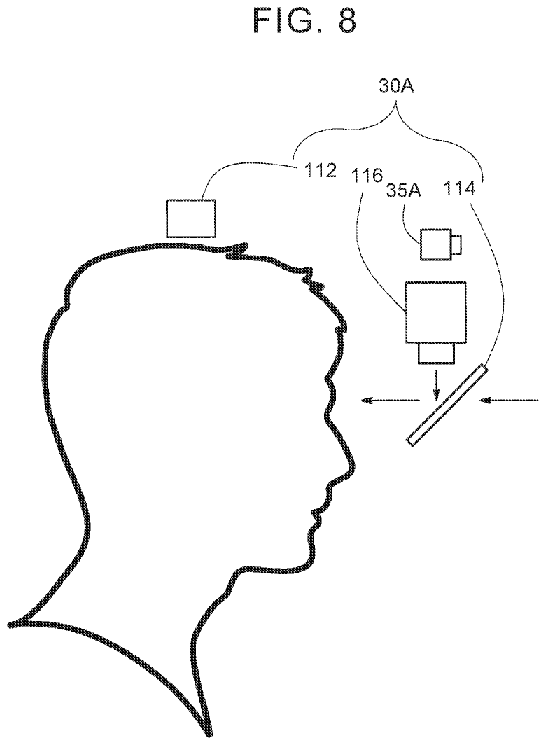

In the above-described embodiment, the display device 30A is exemplified by a smartphone that is a video see-through display. However, the display device 30A according to the present embodiment is not limited to this form. For example, as is the head-mounted display (HMD) as illustrated in FIG. 8, the display device 30A may be composed of an optical see-through display.

In this case, the display device 30A includes the imager 35A, a half mirror 114 corresponding to the display unit 46A, a projector 116 corresponding to the display control unit 45A and the image recognition unit 58, and a sensor unit 112 corresponding to the position information acquisition unit 50.

The half mirror 114 may be, for example, the lenses of eyeglasses or goggles. The half mirror 114 allows light (image) from the real world to be transmitted to the user. The projector 116 disposed above the half mirror 114 projects an image of the virtual object onto the half mirror 114. Thus, it is possible to display an augmented reality image in which the person image 100 of the remote location and the person image 100 on which the decoration image 110 is superimposed are superimposed on the scenery in the complex entertainment facility 10 that is the scenery of the real world.

Other Example of Display Device

In the above-described embodiment, the augmented reality image display flow of FIG. 5 is executed by the display device 30A and the server 70. However, instead of this, the display device 30A may execute all the steps of the flow. In this case, the display device 30A is composed of, for example, a tablet terminal having a storage capacity larger than that of the smartphone.

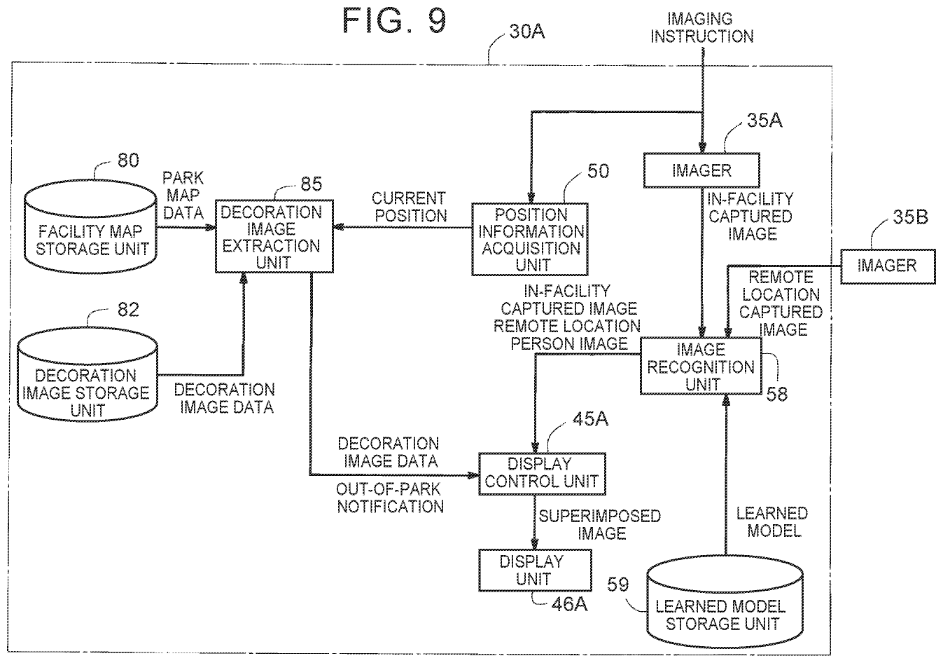

FIG. 9 is a modification of FIG. 4 and illustrates a functional block diagram of the display device 30A. This functional block diagram is configured such that the CPU 31A or the GPU 42 executes a program stored in, for example, the system memory 40A or the storage device 41A. Alternatively, the functional blocks illustrated in FIG. 9 are configured such that the CPU 31A or the GPU 42 executes a program stored in a computer-readable non-transitory storage medium such as a DVD or a hard disk of a computer.

In FIG. 9, as compared with FIG. 4, the display device 30A is provided with the facility map storage unit 80, the decoration image storage unit 82, and the decoration image extraction unit 85. The configurations provided in the server 70 in FIG. 4 are provided in the display device 30A, so that the virtual reality image display flow can be executed by the display device 30A alone. For example, in the flow of FIG. 5, all the steps are executed by the display device 30A. Further, since it is not necessary to exchange data between the display device 30A and the server 70, steps S16 and S28 are unnecessary.

Other Example of Identifier

In the above-described embodiment, the AR marker 35C1 is provided to the surface of the imager 35C as the identifier for the display device 30A to generate an augmented reality image, but the display system according to the present embodiment is not limited to this form. For example, a so-called markerless AR method in which the AR marker 35C1 is not provided to the imager 35C (see FIG. 2) may be adopted. Specifically, the three-dimensional shape of the imager 35C may be used as the identifier.

What is claimed is:

1. A display system comprising:
a display device including
an image recognition unit that recognizes a person image from an image captured at a remote location,
a display control unit configured to superimpose a decoration image on the person image and generate an augmented reality image in which the person image that has been decorated is superimposed on scenery of a real world,
a display unit configured to display the augmented reality image, and
a position information acquisition unit that acquires a position of the position information acquisition unit; and
a server configured to communicate with the display device, the server including
a storage unit in which a plurality of kinds of the decoration images is stored, and
an extraction unit that extracts, from the storage unit, the decoration image based on the position acquired by the position information acquisition unit, as the decoration image to be superimposed on the person image.

2. The display system according to claim 1, wherein:
the display device is disposed in a facility configured based on a specific theme; and
in the storage unit, a character image defined as a character in the facility is stored as the decoration image.

3. The display system according to claim 2, wherein:
an identifier that is imageable is displayed on a device in the facility;
the display device includes an imager configured to capture an image of an inside of the facility; and
when the image recognition unit recognizes the identifier in an in-facility captured image captured by the imager, the display control unit sets an image area including the identifier as a superimposed area of the person image that has been decorated.

4. The display system according to claim 3, further comprising:
a first caller configured to make a call in the facility; and
a second caller configured to make a call with the first caller at the remote location.

5. A display device comprising:
an image recognition unit that recognizes a person image from an image captured at a remote location;
a display control unit configured to superimpose a decoration image on the person image and generate an augmented reality image in which the person image that has been decorated is superimposed on scenery of a real world;
a display unit configured to display the augmented reality image;
a position information acquisition unit that acquires a position of the position information acquisition unit;
a storage unit in which a plurality of kinds of the decoration images is stored; and
an extraction unit that extracts, from the storage unit, the decoration image based on the position acquired by the position information acquisition unit, as the decoration image to be superimposed on the person image.

6. A program that causes a computer to function as:
an image recognition unit that recognizes a person image from an image captured at a remote location;
a display control unit configured to superimpose a decoration image on the person image and generate an augmented reality image in which the person image that has been decorated is superimposed on scenery of a real world;
a display unit configured to display the augmented reality image;
a position information acquisition unit that acquires a position of the position information acquisition unit;
a storage unit in which a plurality of kinds of the decoration images is stored; and
an extraction unit that extracts, from the storage unit, the decoration image based on the position acquired by the position information acquisition unit, as the decoration image to be superimposed on the person image.
